(19) United States
(12) Patent Application Publication
(10) Pub. No.: US 2022/0237031 A1
(43) Pub. Date: Jul. 28, 2022

(54) CAPACITY MIDDLEWARE SYSTEM TO MAKE CAPACITY FLUID AMONG KUBERNETES CLUSTERS TO INCREASE RESOURCE UTILIZATION

(71) Applicant: Flipkart Internet Private Limited, BANGALORE (IN)

(72) Inventors: Abhranil CHATTERJEE, Kolkata (IN); Anuj AGRAWAL, Bangalore (IN); Bhargav Bipinchandra NAIK, Gujarat (IN); Giridhar Appaji NAG YASA, Karnataka (IN); Livingstone SE, Chennai (IN); Neeraj BISHT, Bangalore (IN)

(21) Appl. No.: 17/570,671

(22) Filed: Jan. 7, 2022

(30) Foreign Application Priority Data
Jan. 7, 2021 (IN) 202141000782

(51) Int. Cl. G06F 9/50

(52) U.S. Cl. CPC G06F 9/50; G06F 2209/505

(57) ABSTRACT

This invention makes capacity fluid among multiple kubernetes clusters maintained by an organization by introducing a system and method named capacity middleware to shrink and grow clusters based on their resource requirements. Capacity Middleware, run on the Management Cluster alongside an API controlling Clusters and assigns annotations related to priority on objects of Cluster resource, annotation for no preemption Quota to objects of MachineDeployment specifying the number of resources for each cluster and annotation of valid capacity (capacityValidated) by default set to false on objects of Machine resource which is used by the Capacity Middleware as a signal to respond to these objects. The capacity middleware iteratively checks and frees or assigns resources based needs of different clusters based on difference between required capacity and available capacity. A difference of negative suggests need for preempting resource whereas a difference in positive number suggest additionally required resources.

### FIELD

The present invention relates to sharing resources across different workload clusters, where a capacity middleware is defined on a cluster manager for iteratively identifying preemptable cluster resources across different workload clusters.

### BACKGROUND OF THE RELATED ART

Container orchestration is a popular technique which automates the deployment, management, scaling, and networking of containers. Enterprises that need to deploy and manage hundreds or thousands of containers and hosts can benefit from container orchestration. Container orchestration can be used in any environment where containers are used. It can help to deploy the same application across different environments without needing to redesign it. And various orchestrators in the container orchestrator make it easier to orchestrate services, including storage, networking, and security. Containers make it possible to run multiple parts of an app independently in various workload cluster, on the same or different hardware, with much greater control over individual pieces and life cycles.

Kubernetes is the most popular open source container orchestration engine used today across all spectrums of the software industry. It helps to eliminate human supervision previously required in running “long running” services as well as batch workloads. It is common for organizations to run diverse workloads on multiple kubernetes clusters both on public or private clouds. The Kubernetes clusters are also billed based on their resource usage. Generally, the total resource available to the organization is bound by budget or physical capacity in the public or private cloud. The organization would want to address the scale up demands of these clusters at different times while staying within these bounds.

Kubernetes clusters can host multiple pods, a pod is the smallest unit of an application in Kubernetes with each node. In application hosting, the requirement of nodes is very high in order to run all long running services and batch workloads. The customary way to do this is by using multiple Kubernetes clusters. Each such cluster has a configured minimum and maximum size (within the practical limits of course) and operates at a “just enough” size required to host the pods it needs. There is a tool available in the open source Kubernetes community, namely the Cluster Autoscaler that automatically adjusts the cluster size up or down based on the pods that are required to be run on the cluster. In order to be able to do this, a Cluster Autoscaler needs to talk to an external service (external to the Kubernetes cluster) that will provide a new node (scale up) or take away an existing one (scale down).

Further, a Special Interest Group (SIG) within the open source Kubernetes community, namely Cluster API provides a software system to create, configure and manage multiple Kubernetes clusters. It itself runs in a special Kubernetes cluster, called as the Management Cluster and provides primitives to spawn, manage, scale up or down multiple Kubernetes Workload Clusters (the ones running the “long running” services and/or batch workloads).

The contemporary container orchestration solutions only disclose of a cluster management solution where resources are shared among a cluster nodes and pods. There is a need to make resource utilization fluidic between different clusters hosted by an organization so as to control wastage of resources and sharing of resources across various clusters.

### SUMMARY

In this invention, we solve the problem of making capacity fluid among multiple kubernetes clusters maintained by an organization by introducing a novel system named capacity middleware to shrink and grow clusters based on their resource requirements.

In an embodiment of the present invention for sharing machine objects between one or more workload clusters a Capacity Middleware running on a Management Cluster of a container orchestration engine alongside Clusters, wherein workload cluster consists of one or more machine deployments, each machine deployment is a group of machines that have the same instance type (it) and priority (p) which is assigned at Cluster level, wherein the sharing of the machine objects between workload clusters, comprising of, annotating, by the capacity middleware, priority object (P) on objects of the workload Clusters, receiving, by the capacity middleware, priority information about machine objects of different workload clusters from the Container Orchestrator and grouping by the capacity middleware of one or more Machine objects based on same instance type (it) and priority (p), assigned to their respective clusters, grouping and ordering, by the capacity middleware, the Machines objects within a cluster by their underlying instance type (it) and their cluster priority value (p), giving ordered groups (OGit, p) of machine objects, fetching by the capacity middleware, from the Container Orchestrator, all un-provisioned Machine objects based on instance type (it) and all existing Machine Deployments of underlying instance type (it), to create an ordered group of MachineDeployment objects (MDit) from lower to higher priority of their respective clusters, and
executing concurrently for each ordered group (OGit) and ordered MachineDeployment objects group (MDit), machine object addition or removal from one or more cluster(s) based on a deficit and assigning or preempting the machine objects in an another workload cluster. Wherein Cluster objects are one to one mapped with one or more workload clusters. The priority assigned to a machine object from a cluster is same as priority of that cluster. The priority assigned to a machine deployment object from a cluster is same as priority of that cluster. Further, initializing by the Capacity middleware a counter for each machine deployment for ascertaining number of machines to be added or removed by iteratively checking the ordered group (OGit) from high priority to low priority for each item in ordered group (OGit).

Further, in the present invention performing the step of calculating the deficit by ascertaining difference between required machines for an existing machines available from the infrastructure provider, if the ascertained difference is negative all new un-provisioned machines are approved for provisioning else if the assertion is negative, then existing lower priority machine deployments are evaluated for potential preemption of machines to satisfy the new unprovisioned machine objects. Where for freeing up resources machine deployments can be preempted by producing a map of machine deployments to the number of machines to be added or preempted, if the value (n) corresponding to machine deployments is greater than zero (n>0), it means that machine deployment will get n more machines if n<0, it means the machine deployment will see machines preempted from it.

### BRIEF DESCRIPTION OF THE DRAWINGS

FIG. 1 Component diagram illustrating capacity middleware with other components in the Container orchestration ecosystem.

FIG. 2 Method for executing fluidic capacity management between cluster.

FIG. 3 Flowchart of execution of a threads out of threads 1 . . . N.

FIG. 4 Discloses a plan ‘TransferPlan’ for sharing resources.

FIG. 5 Discloses a fair redistribution algorithm for eviting/preempting machines.

### DETAILED DESCRIPTION

Illustrative embodiments of the present invention will be described herein with reference to exemplary information processing systems and associated devices, storage devices and other processing devices. It is to be appreciated, however, that embodiments of the invention are not restricted to use with the particular illustrative system and device configurations shown. Accordingly, the term “orchestrator”, “container” “workload” ‘Machines’ as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one computer resource that includes one or more processing and controlling tenants that share cloud resources.

Exemplary embodiments now will be described with reference to the accompanying drawings. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like reference numerals refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include operatively connected or coupled. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

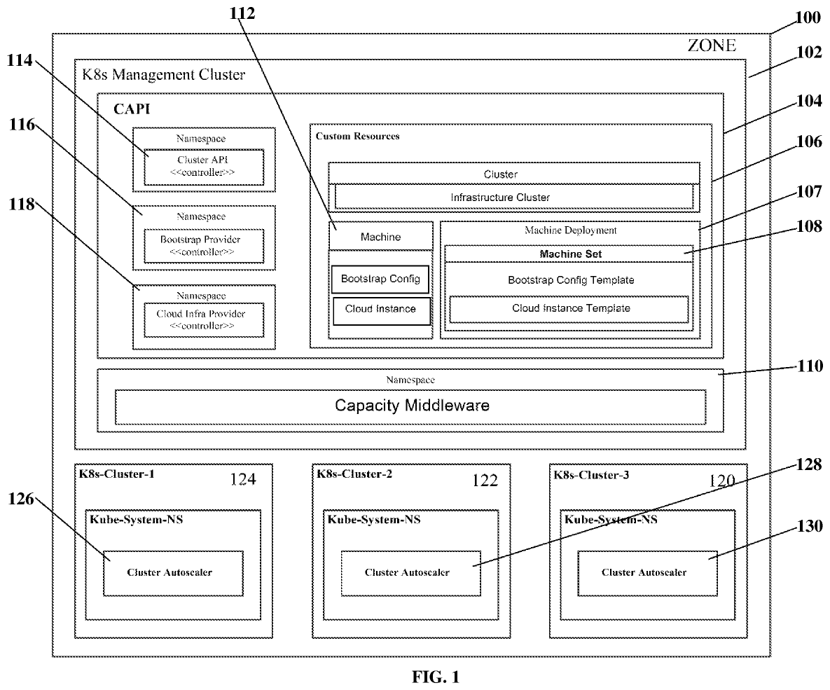

FIG. 1 discloses an exemplary embodiment of the present invention deployed in a kubernetes container orchestrator managed by a management cluster (102) and accessed through a user interface, which has not been depicted here. The kubernetes container orchestrator hosts various clusters (K8s Cluster 1 (120), K8s Cluster 2 (124), K8s Cluster 3(126)), a manager Kubernetes cluster, the clusters consisting of sets of worker machines called nodes, that run various applications. Every cluster (120-124) has at least one worker node. The worker node(s) host the Pods that are the components of the application workload. Autoscaller (126-130) manages the worker nodes of respective clusters (120, 122, 124) and the Pods or machines in these clusters. The control of the number of pods running in the clusters is controlled by autoscaller (126, 128, 130).

As disclosed in FIG. 1, a Management Cluster 102 is running a Cluster API (CAPI 104) and a Capacity Middleware 110. Cluster API 104 is running with a Cloud Infrastructure Provider 118 specific to a cloud service provider 118. Cluster API 104 introduces and manages custom Kubernetes resources, like Clusters (120, 122, 124), MachineDeployment (107), MachineSet (108), Machine (112), BootstrapConfig, cloud instances, etc. Information about the overall capacity or resources available from the cloud provider 118 is stored in the Management Cluster 102 as a map between cloud instance type to capacity. Clusters {120, 122, 124) are the workload clusters that are spawned and managed by Cluster API.

Kubernetes runs workload by placing containers into Pods to run on Nodes. A person skilled in the art will realize that a node may be a virtual or physical machine, depending on the cluster. Each node contains the services necessary to run Pods.

Each of the autoscaller 126-130 are assigned with keeping the node controller's internal list of nodes up to date with the cloud provider's list of available machines. When running in a cloud environment, whenever a node is to be removed, the node controller asks the cloud provider if the VM for that node is still available. If not, the node controller deletes the node from its list of nodes.

The autoscallers (126-130) are responsible for updating the number of pods when a pod becomes preemptable and then later evicting all the pods from the node.

In container orchestrator 100 the Capacity middleware 110 running on the Management cluster 102 assigning priority (p) object on objects of clusters 120, 122, 124. The assignment of priority objects consists of assigning similar priority to all objects a cluster for example cluster 120 is assigned a priority P1, cluster objects of cluster 122 are assigned priority P2 and cluster objects of cluster 123 are assigned priority P3. Where P1 has higher priority value compared to priority value P2 which has a higher priority over priority P3.

In container orchestrator 100 the Cluster API 104 running on the Management cluster 102 assigns label ‘noPreemptionQuota’ to the objects of the MachineDeployment 107. The object ‘noPreemptionQuota’ defines the limit of the machines or pods that can be hosted by an application or cluster. The MachineDeployment 107 is a custom resource defined by Cluster API 104 to represent a set of machines with identical resources within a cluster. Kubernetes use annotations or labels to attach arbitrary non-identifying metadata to objects. Clients such as tools and libraries can retrieve this metadata. One can use either labels or annotations to attach metadata to Kubernetes objects. Labels can be used to select objects and to find collections of objects that satisfy certain conditions.

In container orchestrator 100 the Cluster API 104 running on the Management cluster 102 assigns a label of ‘capacityValidated’ which is by default set to ‘false’ on objects of Machine resource which is used by the Capacity Middleware as a signal to respond to these objects.

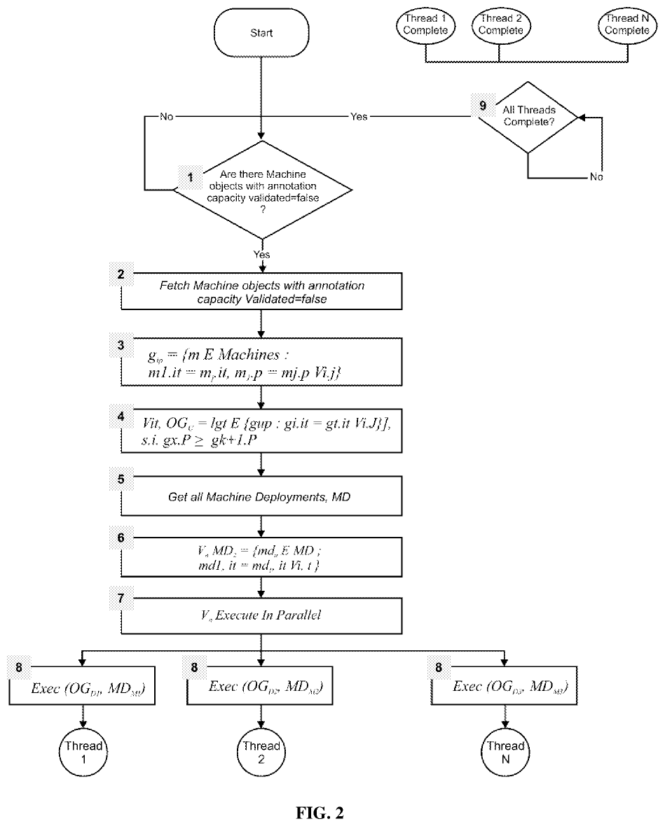

FIG. 2 discloses a method for making capacity fluid among Kubernetes Clusters to increase resource utilization. The Capacity middleware 110 keeps looping forever until terminated externally, in Step 1, Capacity middleware 110 checks for Machine objects with annotation capacityValidated as ‘false’. In case there are no such objects, Capacity middleware 110 repeats step 1 after a small interval. In Step 2, Capacity middleware 110 fetches Machine objects with capacityValidated annotation as ‘false’ from the Management Cluster 102. In Step 3, Capacity middleware 110 groups Machine objects with capacityvalidated ‘false’ derived in step 2, where in each group all machines have same instance type (it) and same priority (P) as a machine's priority P is the same as its owner cluster's priority. Thus, we get a groups of machines (gᵢₜ), which can also be illustrated as produced below which is illustrated for clarity purposes only, like:

gᵢₜ,p={m∈Machines:mᵢ.it=mⱼ.it,mⱼ.p=mj.p∀_{i,j}}},s.t. gₖ.P≥gₖ₊₁.P

In Step 4, Capacity middleware 110 further groups (Gᵢₜ) the group of machines (gᵢₜ) with the same instance type ‘it’ and orders the groups within Gᵢₜ by priority P (P1, P2, P3) of the machines, from high to low, giving an ordered groups (OGᵢₜ) where:

∀ᵢₜ,OGᵢₜ={gₖ∈{gᵢₜ,p:gᵢ.it=gⱼ.it ∀_{i,j}}},s.t. gₖ.P≥gₖ₊₁.P

In Step 5, Capacity middleware 110 fetches all objects of MachineDeployment resource from the API Server of the Management Cluster 102. In Step 6, Capacity middleware 110 groups the MachineDeployment objects, wherein in each group all machineDeployments have the same instance type (it). Thus, in step 5 machinedeployment objects are grouped as groups (∀MDᵢₜ), where ∀MDᵢₜ={md∈MD:mdᵢ.it=mdⱼ.it ∀_{i,j}}.

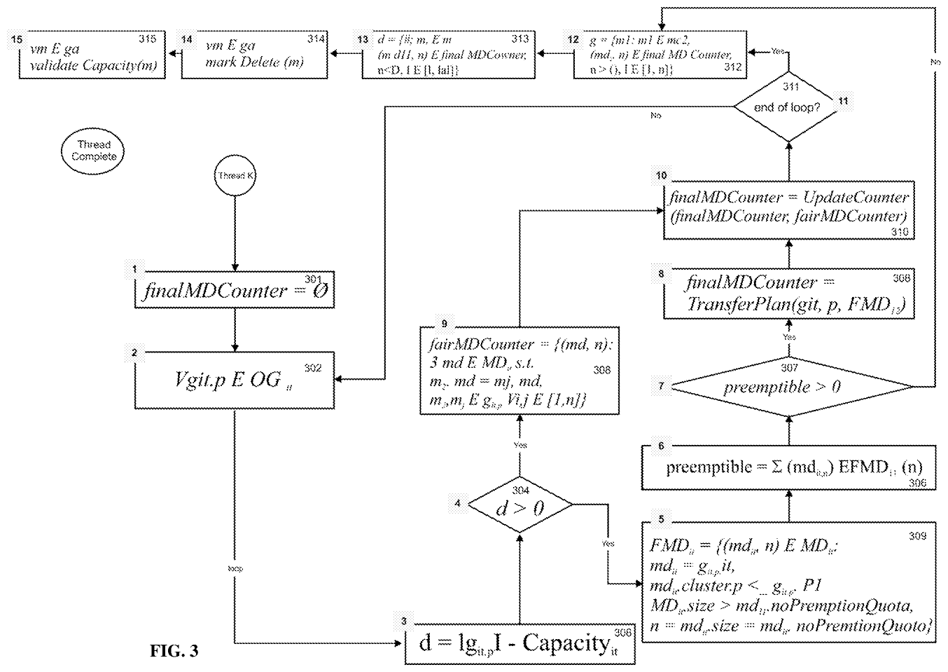

In Step 7, Capacity middleware 110 parallelly executes of for each ordered group OGit and set of MachineDeployment's of instance ‘it’ (MDit) a procedure for ascertaining number of machine deployments or resources that are to be removed or added, the process of represented as ‘Exec(OGit, MDit)’ for simplicity. In Step 8, for each ordered group OGit and set of MachineDeployment's of instance type (it), Exec(OGit, MDit) is counting number of machine deployments to number of machines to be added or removed. This method Exec(OGit, MDit) runs in each threads (k1, k2, K3) parallelly with other such threads (K). FIG. 3 illustrate a parallel execution of thread separately.

In Step 9, Capacity middleware 110 waits for all the threads (K) to finish their job. Once all threads have finished, Capacity middleware 110 goes back to Step 1, of FIG. 2.

As shown in the figure of FIG. 3, execution of a Thread is happening in parallel to other threads 1 to N.

In Step 301, Capacity middleware 110 initialises a counter ‘finalMDCounter’ of machine deployments to number of machines to be added or removed, the finalMDCounter sets it to empty, this counter represent the number of machines that are to be added and evicted, as explained below.

In Step 302, Capacity middleware 110 iterates over the ordered group OGit from high priority to low priority for each group of instance (git,p) where in each group all machines have same instance type (it) and same priority (P).

In Step 303, Capacity middleware 110 calculates a deficit (d) of instances of type ‘it’ that are required versus those that are available; deficit can be positive signifying that need for more machine or can be negative signifying excess capacity is needed. Capacity middleware 110 checks the number of instances ‘it’ available from the API Server of the Management Cluster, namely Capacityit. The deficit (d) is calculated as: d=Igᵢₜ, p|—Capacityit where |git, p| gives the number of machines in the group gᵢₜ, p as disclosed in step 3 of FIG. 2.

In Step 4, Capacity middleware 110 checks if the value of deficit (d) derived in step 303 is positive. If deficit is negative or zero, Capacity middleware 110 indicates that the entire group gᵢₜ,p can be satisfied from available capacity and Capacity middleware 110 does not need to look for capacity from other clusters. In this case it goes to Step 309, disclosed below. However, if the value of deficit (d) is positive, it needs to look for capacity from other clusters and proceeds to Step 5. In Step 5, Capacity middleware 110 computes Filtered Machine Deployments (FMDᵢₜ) by filtering the group of machine deployments MDᵢₜ by:
priority of machine deployment equal to the priority mdᵢₜ.p of the group of machines g_{it, p}.p; and
cluster priority mdᵢₜ.cluster.p is less or equal to the priority of the group of machines g_{it, p}.p; and
Size of machine deployment (mdᵢₜ.size) is greater than its noPreemptionQuota, mdᵢₜ.noPreemptionQuota.

The computed value of FMDᵢₜ is equal to (mdᵢₜ, n) where tuple (mdᵢₜ, n) here implies that machine deployment mdᵢₜ has ‘n’ machines above its noPreemptionQuota and hence are preemptible.

In Step 306, the number of ‘preemptible’ instances across all machine deployments in FMDᵢₜ is computed by summing ‘n’ the second elements of each tuple, ‘preemptible’=Σ(mdᵢₜ, n)∈FMDᵢₜⁿ.

In Step 307, Capacity middleware 110 checks if the number of preemptible instances across all machine deployments in FMDᵢₜ is positive (>0). If so, it proceeds to Step 308. If not, Capacity middleware 110 indicates it cannot satisfy the requirements of current and subsequent iterations of git, p∈OGit and thus comes out of the iteration and jumps to Step 312.

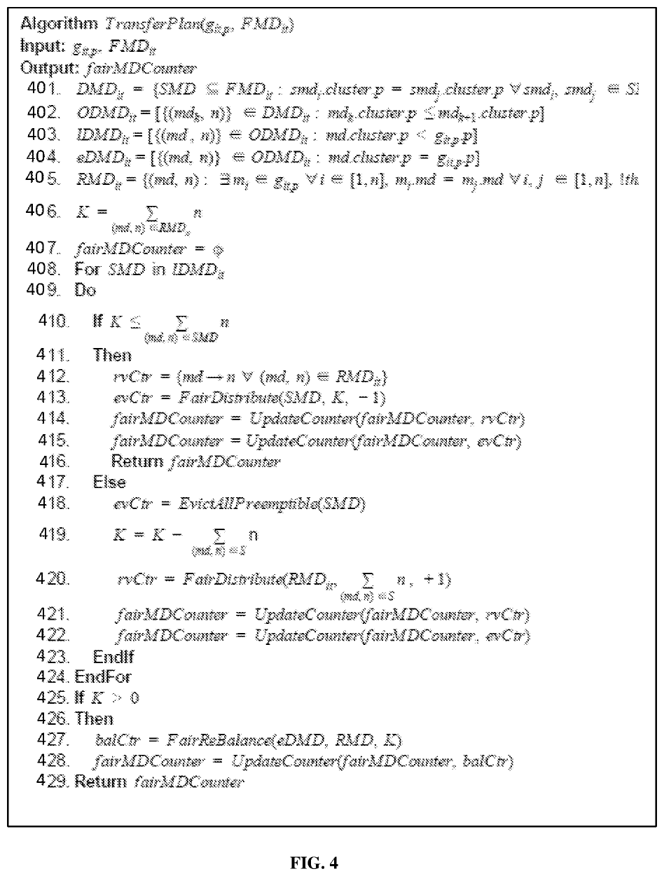

In Step 308, Capacity middleware 110 runs a procedure—TransferPlan (git, p, FMDit), which generates a plan for satisfying machine requirements in gᵢₜ, p as much as possible while evicting machines from the machine deployments in FMDᵢₜ. Capacity middleware 110 generates TransferPlan plan by producing a counter of machine deployments to some values. If the value corresponding to a machine deployment is n>0, it means that machine deployment will get n more machines. If n<0, it means the machine deployment will see ‘n’ machines preempted from it. Kindly refer to FIG. 4 for procedure TransferPlan (git,o, FMDᵢₜ). Capacity middleware 110 then moves to Step 310.

In Step 309, Capacity middleware 110 had arrived from Step 304 as there was no or negative deficit of capacity. So, all machines in git,p can be validated. It is expressed by grouping all machines in gᵢₜ,p by their machine deployments and producing a counter, fairMDCounter of machine deployment to the number of machines to be added.

In Step 310, finalMDCounter is updated with the counter fairMDCounter generated in Step 8.

In Step 311, Capacity middleware 110 iterates among all the instance in git, pin OGᵢₜ. If there are more iterations Capacity middleware 110 goes to Step 2. Otherwise, it continues to Step 312. Thus, the capacity utilization for all the instances in gᵢₜ.p is collected which gives information about resources that can be freed or needed among cluster.

In Step 312, Capacity middleware 110 checks finalMDCounter for machine deployments (md, n) with n>0; n machines are selected arbitrarily from each such machine deployment and added to gₐ group of machines for which capacity needs to be validated.

In Step 313, Capacity middleware 110 checks finalMDCounter for machine deployments (md, n) with n<0; n machines are selected arbitrarily from each such machine deployment and added to gd, the group of machines that need to be preempted.

In Step 314, Capacity middleware 110 marks each machine in group (g_{d}) as deleted by updating its existing annotation of deletedTimestamp to current time. The actual deletion will be done by API for Cluster as a result of this annotation being updated and is out of scope of the capacity middleware. It then proceeds to Step 310.

In Step 315, annotation capacityValidated is marked as true for all machines in gₐ and completes the thread to give ordered machine deployments. In case, two OMDᵢₜ machine deployments have equal cluster priority, the machine deployment with a higher preemptibility score mdᵢₜ.preScore gets precedence.

FIG. 4 discloses the TransferPlan (gᵢₜ,o, FMDᵢₜ) which generates the plan in the form of a counter of machine deployments to values indicating number of machines to be added (when positive) or removed (when negative) as outlined in the previous subsection. The internals of this procedure are explained below:

In Step 401, the machine deployments having the same cluster priority are grouped in to one group, the donor machine deployments (SMD), and DMD is the set of all such groups of machine deployments from which machines can be preempted, which is described above.

In Step 402, the groups in DMD are sorted based on their machine deployments' priority from lower to higher to give ODMDᵢₜ.

In Step 403 and Step 404, ODMDᵢₜ is partitioned into partitioned group ‘lDMDᵢₜ’, those groups of machine deployments having lesser cluster priority than the current requesting group gᵢₜ,p in consideration, and eDMDᵢₜ having same cluster priority as the machines in gᵢₜ,p. In the present invention in order to meet the machine requirements in gᵢₜ,p capacity middleware 110 can be more aggressive while planning to evict machines from lDMDᵢₜ as they have lesser priority, but we need to be conservative while evicting machines from eDMDᵢₜ as they have the same priority.

In Step 405, the machines in gᵢₜ,p are also grouped by their machine deployments to give RMDᵢₜ, the receiving set of machine deployments. Those machine deployments for which thrash(md, p) is true are pruned out thrash (md, p) returns true if and only if ‘md’ has undergone machine preemption within a configurable thrash-protection-interval where the recipient machine deployments were at the same priority as md.cluster.p. This helps to prevent the scenario where two machine deployments having the same cluster priority are constantly preempting machines from each other.

In Step 406, K, the total number of machines across all machine deployments in RMDit (that is the number of machines in git,p) is computed.

In Step 307, as described above, fairMDCounter is set to empty, the value of fairMDCounter is then replaced by the ‘TransferPlan’ counter value which will eventually return value containing the number of machines to be added or removed from a set of machine deployments.

From Step 408 to Step 424, Capacity middleware 110 runs a loop over each SMD∈lDMDit and tries to aggressively preempt from SMD. If entire K machines can be preempted, then receiving counter rvCtr and eviction counter evCtr are computed. rvCtr will have all machine deployments in RMDit with their entire values as every requirement can be met. However, evCtr is computed by fairly distributing eviction among all machine deployments in SMD. This fair distribution is further explained below. fairMDCounter is updated with rvCtr and evCtr and returned. If less than K machines can be preempted from SMD, then all preemptible machines in SMD are to be evicted and evCtr is computed accordingly. In this case, the number of machines that could be evicted are distributed fairly among the receiver machine deployments, RMDit.

In Step 425 to Step 428, if the remaining number of machines required, K is still positive, then a fair rebalance of machines need to be carried out among the machine deployments in eDMDit and RMDit as all of them have the same priority. The fair rebalance algorithm simply plans eviction of upto K preemptible machines fairly from the machine deployments in eDMDit and plans distribution of these machines fairly among the machine deployments in RMDit. The result of FairReBalance(eDMDit, RMDit, K) is a balanced machine deployment counter, balCtr, where positive number indicates adding of machine deployments or removed (negative number) for a machine deployment. The fairMDCounter is then updated with balCtr.

In Step 429, the algorithm returns the counter fairMDCounter which captures a map of machine deployments to the number of machines to be added. A negative number implies that many numbers of machines have to be preempted from the corresponding machine deployment.

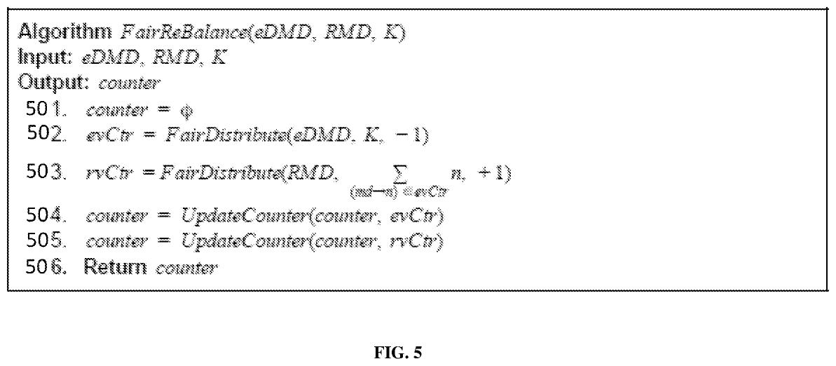

FIG. 5 discloses the FairDistribute (SMD, K, sgn) procedure that indicates the number of machines that have to be distributed fairly among the machine deployments. The FairDistribute(SMD, K, sgn) procedure takes as input SMD, a set of tuples of the form (md, n), where md is machine deployment and n represent number of machines and a positive number K indicating the number of machines that have to be distributed fairly among the machine deployments in SMD. The sgn is an indicator variable having possible values of +1 indicating machines have to be added and −1 indicating machines have to be preempted (evicted).

Capacity middleware 110 computes a distribution score for each machine deployment in SMD with ComputeDistributeScore(md). It is possible to configure multiple strategies to compute this score. One strategy can be to use the number of preemptible instances in a machine deployment proportional to its noPreemptionQuota. This will lead to deciding on numbers of machines to be preempted or added to a machine deployment based on its current usage or number of machine deployment above its noPreemptionQuota. Alternately, a strategy can be to assign score of 1 to all machine deployments in. In this, case machines will be added or SMD preempted uniformly across all machine deployments in SMD. The scores are normalized on all the machine deployments in SMD and numbers of machines are assigned to a machine deployment as per its normalized md.score times K.

The Capacity middleware 110 also perform a FairRebalance (eDMD, RMD, K) which takes a donor set of machine deployments eDMD, a recipient set of machine deployments RMD and K the number of machines RMD expects to receive and sets an eviction plan in the form of evCtr by doing a distribution (FairDistribute) of K machines on eDMD with sign=−1 indicating machines are to be evicted. Following that Capacity middleware 110 computes an addition plan in the form of rvCtr by doing a FairDistribute of Σn machines, that is Σn machines, that is

$${\sum }_{( md \to n ) ∈ evCtr} n$$

the total number of machines that could be evicted from eDMD, across all machine deployments in RMD with sign=+1 indicating machines are to be added. It returns a counter of machine deployments where each machine deployment is mapped to a positive number (machines to be added) or a negative number (machines to be removed).

It is to be observed that the FairReBalance algorithm, transferPlan for sharing resources may run on the capacity middleware or under thread or sub-processes. The machines are operating or controlled vide the API of management clusters.

While the above disclosure have been described with reference to the accompanying drawings, it is to be understood that the present disclosure is not limited to the disclosed embodiments, but, on the contrary, is intended to cover various modifications and equivalent arrangements included within the spirit and scope of the appended claims.

We claim:

1. A method for sharing machine objects between one or more workload clusters by a Capacity Middleware running on a Management Cluster of a container orchestration engine alongside Cluster, wherein workload cluster consists of one or more machine deployments, each machine deployment is a group of machines that have the same instance type (it) and priority (p) which is assigned at Cluster level, wherein the sharing of the machine objects between workload clusters, comprising of:
annotating, by the capacity middleware, priority object (P) on objects of the workload Clusters;
receiving, by the capacity middleware, priority information about machine objects of different workload clusters from the Container Orchestrator and grouping by the capacity middleware of one or more Machine objects based on same instance type (it) and priority (p), assigned to their respective clusters;
grouping and ordering, by the capacity middleware, the Machines objects within a cluster by their underlying instance type (it) and their cluster priority value (p), giving ordered groups (OGit, p) of machine objects;
fetching by the capacity middleware, from the Container Orchestrator, all un-provisioned Machine objects based on instance type (it) and all existing Machine Deployments of underlying instance type (it), to create an ordered group of MachineDeployment objects (MDit) from lower to higher priority of their respective clusters; and
executing concurrently for each ordered group (OGit) and ordered MachineDeployment objects group (MDit), machine object addition or removal from one or more cluster(s) based on a deficit and assigning or preempting the machine objects in an another workload cluster.

2. The method as claimed in claim 1, wherein Cluster objects are one to one mapped with one or more workload clusters.

3. The method as claim in claim 1, the priority assigned to a machine object from a cluster is same as priority of that cluster.

4. The method as claim in claim 1, the priority assigned to a machine deployment object from a cluster is same as priority of that cluster.

5. The method as claimed in claim 1 consists of, initializing by the Capacity middleware a counter for each machine deployment for ascertaining number of machines to be added or removed by iteratively checking the ordered group (OGit) from high priority to low priority for each item in ordered group (OGit).

6. The method as claimed in claim 1 consists of, calculating the deficit by ascertaining difference between required machines for an existing machines available from the infrastructure provider, if the ascertained difference is negative all new un-provisioned machines are approved for provisioning else if the assertion is negative, then existing lower priority machine deployments are evaluated for potential preemption of machines to satisfy the new unprovisioned machine objects.

7. The method as claimed in claim 5, for free up resources machine deployments can be preempted by producing a map of machine deployments to the number of machines to be added or preempted, if the value (n) corresponding to machine deployments is greater than zero (n>0), it means that machine deployment will get n more machines if n<0, it means the machine deployment will see machines preempted from it.
